(19) United States
(12) Patent Application Publication
(10) Pub. No.: US 2011/0243220 A1
(43) Pub. Date: Oct. 6, 2011

(54) METHOD AND APPARATUS FOR ENCODING AND DECODING IMAGE AND METHOD AND APPARATUS FOR DECODING IMAGE USING ADAPTIVE COEFFICIENT SCAN ORDER

(75) Inventors: Vadim SEREGIN, Suwon-si (KR); Jianle CHEN, Suwon-si (KR); Woo-jin HAN, Suwon-si (KR); Tammy LEE, Seoul (KR)

(73) Assignee: SAMSUNG ELECTRONICS CO., LTD., Suwon-si (KR)

(21) Appl. No.: 13/080,157

(22) Filed: Apr. 5, 2011

Related U.S. Application Data
(60) Provisional application No. 61/320,826, filed on Apr. 5, 2010.

(30) Foreign Application Priority Data
Sep. 1, 2010 (KR) 10-2010-0085508

(51) Int. Cl. H04N 7/28

(52) U.S. Cl. 375/240.02; 375/E07.126

(57) ABSTRACT

Provided are a method and apparatus for encoding an image and a method and apparatus for decoding an image using an adaptive coefficient scan order. The method for encoding the image includes: projecting coefficients of a current block to a reference axis, from among a horizontal axis and a vertical axis, along a first straight line perpendicular to a second straight line with a predetermined angle α from the reference axis; scanning the coefficients of the current block in an arrangement order of the projected coefficients projected to the reference axis; and entropy-encoding information about the predetermined angle α and the scanned coefficients.

### CROSS-REFERENCE TO RELATED PATENT APPLICATIONS

This application claims the benefit of U.S. Provisional Application No. 61/320,826, filed on Apr. 5, 2010, and Korean Patent Application No. 10-2010-0085508, filed on Sep. 1, 2010 in the Korean Intellectual Property Office, the disclosures of which are incorporated herein in their entireties by reference.

### BACKGROUND

1. Field

Apparatuses and methods consistent with exemplary embodiments relate to encoding an image and decoding an image, and more particularly, to encoding coefficient information and decoding coefficient information by using various coefficient scan orders.

2. Description of the Related Art

An image compression scheme divides an original image into blocks each having a predetermined size, and generates a predicted image by performing inter prediction or intra prediction in units of blocks. Also, the image compression scheme transforms, quantizes, and entropy-encodes residual data that is a difference between the predicted image and the original image. Transform coefficients obtained after transformation and quantization may be encoded by an encoder to have a smaller size before being stored or transmitted. When the encoder outputs the encoded transform coefficients, many coefficients whose values are 0 exist in a high frequency component.

### SUMMARY

Aspects of exemplary embodiments provide an adaptive coefficient scan order which may improve image compression efficiency by effectively arranging coefficients.

Aspects of exemplary embodiments also provide a method and apparatus for encoding an image and a method and apparatus for decoding an image using an adaptive coefficient scan order, which may efficiently define various scan orders by using only one parameter.

According to an aspect of an exemplary embodiment, there is provided a method of encoding an image using an adaptive coefficient scan order, the method including: projecting coefficients of a current block to a reference axis, from among a horizontal axis and a vertical axis, along a first straight line perpendicular to a second straight line with a predetermined angle α from the reference axis; scanning the coefficients of the current block in an arrangement order of the projected coefficients projected to the reference axis; and entropy-encoding information about the predetermined angle α and the scanned coefficients.

According to an aspect of another exemplary embodiment, there is provided an apparatus for encoding an image using an adaptive coefficient scan order, the apparatus including: a scanning unit which projects coefficients of a current block to a reference axis, from among a horizontal axis and a vertical axis, along a first straight line perpendicular to a second straight line with a predetermined angle αfrom the reference axis, and scans the coefficients of the current block according to an arrangement order of the projected coefficients projected to the reference axis; and an entropy-encoding unit which entropy-encodes information about the predetermined angle α and the scanned coefficients.

According to an aspect of another exemplary embodiment, there is provided a method of decoding an image using an adaptive coefficient scan order, the method including: acquiring angle information about a predetermined angle α for determining a scan order of coefficients of a current block to be decoded from a bitstream; using the predetermined angle α, projecting the coefficients of the current block to a reference axis, from among a horizontal axis and a vertical axis, along a first straight line perpendicular to a second straight line with the predetermined angle α from the reference axis, and determining the scan order based on an arrangement order of the projected coefficients projected to the reference axis; and scanning the coefficients of the current block from the bitstream in the determined scan order.

According to an aspect of another exemplary embodiment, there is provided an apparatus for decoding an image using an adaptive coefficient scan order, the apparatus including: an entropy-encoding unit which acquires angle information about a predetermined angle α for determining a scan order of coefficients of a current block to be decoded from a bitstream; and a scanning unit which, using the predetermined angle α, projects the coefficients of the current block to a reference axis, from among a horizontal axis and a vertical axis, along a first straight line perpendicular to a second straight line with the predetermined angle α from the reference axis, to determine the scan order based on an arrangement order of the projected coefficients projected to the reference axis, and scans the coefficients of the current block from the bitstream in the determined scan order.

According to an aspect of another exemplary embodiment, there is provided a method of encoding an image using an adaptive coefficient scan order, the method including: scanning coefficients of a current block according to a determined scanning order; entropy-encoding information about a predetermined angle α and the scanned coefficients, wherein the scanning order is determined to correspond to an arrangement order of the coefficients projected to a reference axis, from among a horizontal axis and a vertical axis, along a first straight line perpendicular to a second straight line with the predetermined angle α from the reference axis.

### BRIEF DESCRIPTION OF THE DRAWINGS

The above and other features and advantages will become more apparent by describing in detail exemplary embodiments with reference to the attached drawings in which:

FIG. 1 is a reference diagram illustrating a block to be scanned in a zigzag scan order;

FIG. 2 is a reference diagram illustrating a block to be scanned in a vertical scan order;

FIG. 3 is a reference diagram illustrating a block to be scanned in a horizontal scan order;

FIG. 4 is a block diagram illustrating an apparatus for encoding an image using an adaptive coefficient scan order, according to an exemplary embodiment;

FIG. 5 is a reference diagram for explaining an adaptive scan order according to an exemplary embodiment;

FIG. 6 is a reference diagram illustrating a scan order applied to coefficients of a 4×4 block, according to an exemplary embodiment;

FIG. 7 is a diagram illustrating coefficients scanned in the scan order of FIG. 6, according to an exemplary embodiment;

FIG. 8 is a flowchart illustrating a method of encoding an image using an adaptive coefficient scan order, according to an exemplary embodiment;

FIG. 9 is a block diagram illustrating an apparatus for decoding an image using an adaptive coefficient scan order, according to an exemplary embodiment; and

FIG. 10 is a flowchart illustrating a method of decoding an image using an adaptive coefficient scan order, according to an exemplary embodiment.

### DETAILED DESCRIPTION OF EXEMPLARY EMBODIMENTS

Exemplary embodiments will now be described more fully with reference to the accompanying drawings.

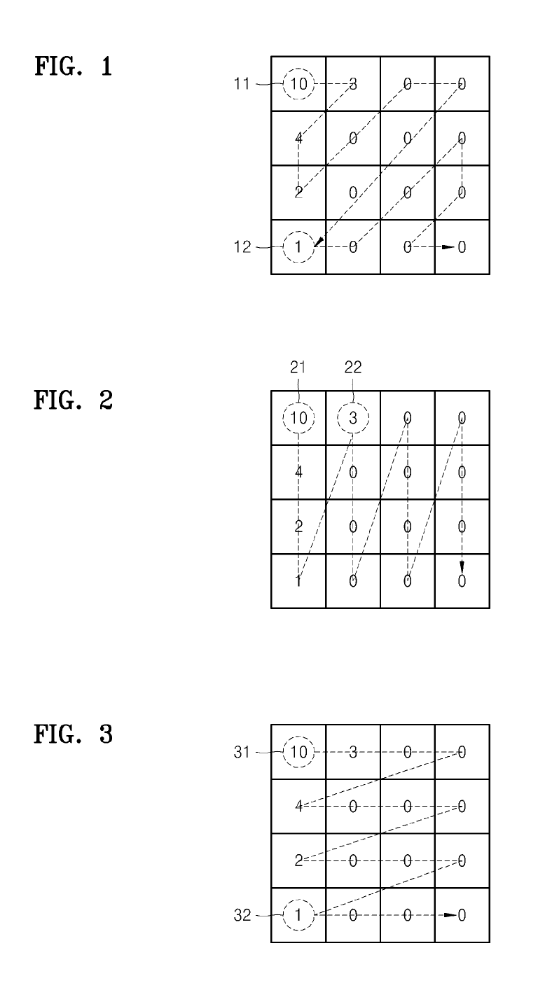

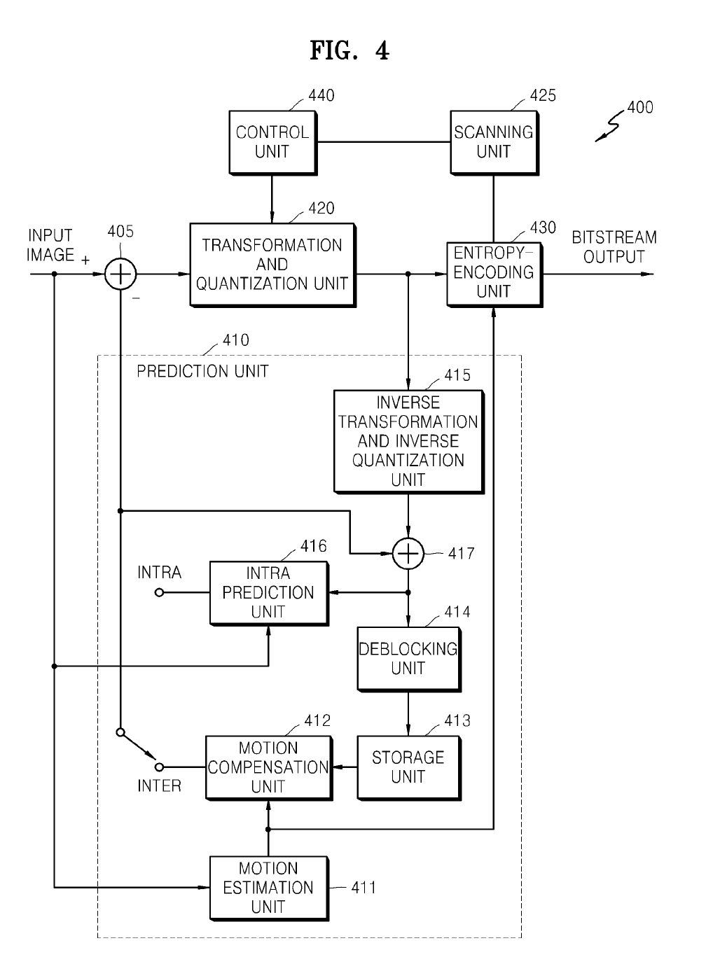

FIGS. 1 through 3 are reference diagrams for explaining a difference between coefficients which are rearranged in coefficient scan orders. FIG. 1 illustrates coefficients arranged in a zigzag scan order, FIG. 2 illustrates coefficients arranged in a vertical scan order, and FIG. 3 illustrates coefficients arranged in a horizontal scan order.

Referring to FIG. 1, if coefficients of a current block are sequentially scanned in a zigzag scan order starting from a direct current (DC) coefficient 11, the scanned coefficients are {10, 3, 4, 2, 0, 0, 0, 0, 0, 1, 0, 0, 0, 0, 0, 0}. During significant map encoding, scanning is performed until a last significant transform coefficient 12 is reached, an end of block (EOB) flag indicating whether each coefficient is a last significant transform coefficient is allocated to the last significant transform coefficient 12, and scanning is substantially not performed after the last significant transform coefficient 12.

Referring to FIG. 2, if coefficients of a current block are sequentially scanned in a vertical scan order starting from a DC coefficient 21, the scanned coefficients are {10, 4, 2, 1, 3, 0, 0, 0, 0, 0, 0, 0, 0, 0, 0, 0}. During a significant map encoding, scanning is performed until a last significant transform coefficient 22 is reached, an EOB flag indicating whether each coefficient is a last significant transform coefficient is allocated to the last significant transform coefficient 22, and scanning is substantially not performed after the last significant transform coefficient 22.

Referring to FIG. 3, if coefficients of a current block are sequentially scanned in a horizontal scan order starting from a DC coefficient 31, the scanned coefficients are {10, 3, 0, 0, 4, 0, 0, 0, 2, 0, 0, 0, 1, 0, 0, 0}. During a significant map encoding, scanning is performed until a last significant transform coefficient 32 is reached, an EOB flag indicating whether each coefficient is a last significant transform coefficient is allocated to the last significant transform coefficient 32, and scanning is substantially not performed after the last significant transform coefficient 32.

Since the coefficients are rearranged through scanning in order to gather coefficients other than coefficients whose values are 0, when coefficients of a current block are to be rearranged as shown in FIGS. 1 through 3, a vertical scan order is a most efficient scan order. As such, when coefficients of the same current block are scanned, arrangement types where coefficients are rearranged are changed depending on scan orders. However, if various scan orders are used, since information about which scan order is applied to the current block is to also be encoded, the number of bits to be transmitted as additional information increases. Accordingly, scanning is generally performed in a predefined scan order. Accordingly, one or more exemplary embodiments may define various can orders with an angle and efficiently compress an image by reducing the number of bits added to define the various scan orders.

FIG. 4 is a block diagram illustrating an apparatus 400 for encoding an image using an adaptive coefficient scan order, according to an exemplary embodiment.

Referring to FIG. 4, the apparatus 400 includes a subtraction unit 405, a prediction unit 410, a transformation and quantization unit 420, an entropy-encoding unit 430, a scanning unit 425, and a control unit 440.

The prediction unit 410 divides an input image into blocks, each having a predetermined size, and generates a predicted block by performing inter prediction or intra prediction on each of the blocks. In detail, a motion estimation unit 411 performs motion estimation that generates a motion vector indicating a region similar to a current block in a predetermined search range of a reference picture that is previously encoded and then reconstructed. A motion compensation unit 412 performs motion compensation that generates a predicted block of the current block by acquiring corresponding region data of the reference picture indicated by the motion vector. Also, an intra prediction unit 416 performs intra prediction that generates a predicted block by using data of neighboring blocks adjacent to the current block.

The subtraction unit 405 generates residual data by subtracting the predicted block of the current block generated by the prediction unit 410 from original image data. The transformation and quantization unit 420 transforms the residual data into a frequency domain by performing frequency transformation such as discrete cosine transformation (DCT), and quantizes the frequency domain to output quantized transform coefficients. Herein, the term “transform coefficients” refers to coefficients which are transformed and quantized by the transformation and quantization unit 420.

The scanning unit 425 rearranges the transform coefficients output from the transformation and quantization unit 420 in a coefficient scan order that is defined by using a predetermined angle α and then outputs the rearranged transform coefficients. Adaptive coefficient scanning performed by the scanning unit 425 will be explained in detail below.

The entropy-encoding unit 430 performs variable-length coding on the transform coefficients to generate a bitstream. The entropy-encoding unit 430 encodes the transform coefficients by generating additional information such as size information and a significant map of the transform coefficients.

An inverse transformation and inverse quantization unit 415 reconstructs the residual data by performing inverse quantization and inverse transformation. An addition unit 417 reconstructs the current block by adding the predicted block to the reconstructed residual data. The reconstructed current block passes through a deblocking filter 414, is stored in a storage unit 413, and is used as reference data of a next block.

The control unit 440 controls each element of the apparatus 400, and determines a prediction mode and a scan order for encoding of the current block by, for example, comparing costs of the bitstream, e.g., rate-distortion (RD) costs, according to scan orders, which will be explained in detail below.

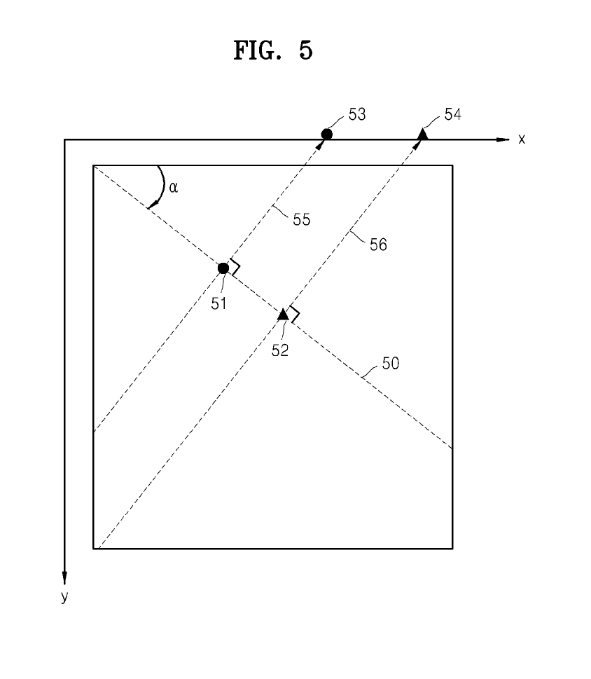

FIG. 5 is a reference diagram for explaining an adaptive scan order according to an exemplary embodiment.

Referring to FIG. 5, in order to scan coefficients of a current block, the scanning unit 425 projects each of the coefficients of the current block to an axis, selected as a reference axis from among a horizontal axis x and a vertical axis y, along a straight line perpendicular to a straight line with a predetermined angle α, which ranges from 0 to 90 degrees, from the reference axis. For example, as shown in FIG. 5, coefficients 51 and 52 are projected to the horizontal axis x along straight lines 55 and 56 perpendicular to a straight line 50 with the predetermined angle α from the horizontal axis x.

Depending on an arrangement order of projected coefficients 53 and 54, in which order the coefficients are to be scanned is determined. In general, since a low frequency component including a DC coefficient may be more likely to have a value other than 0, coefficients may be sequentially scanned in an arrangement order in which projected coefficients projected to a reference axis are arranged on the reference axis starting from the DC coefficient. If coefficients are projected to the same position on a reference axis because, for example, the predetermined angle α is 0, 45, or 90 degrees, coefficients close to the reference axis may be first scanned. In this case, if the predetermined angle α is 0 degrees, a scan order is determined to be a vertical scan order, if the predetermined angle α is 45 degrees, a scan order is determined to be a zigzag scan order, and if the predetermined angle α is 90 degrees, a scan order is determined to be a horizontal scan order.

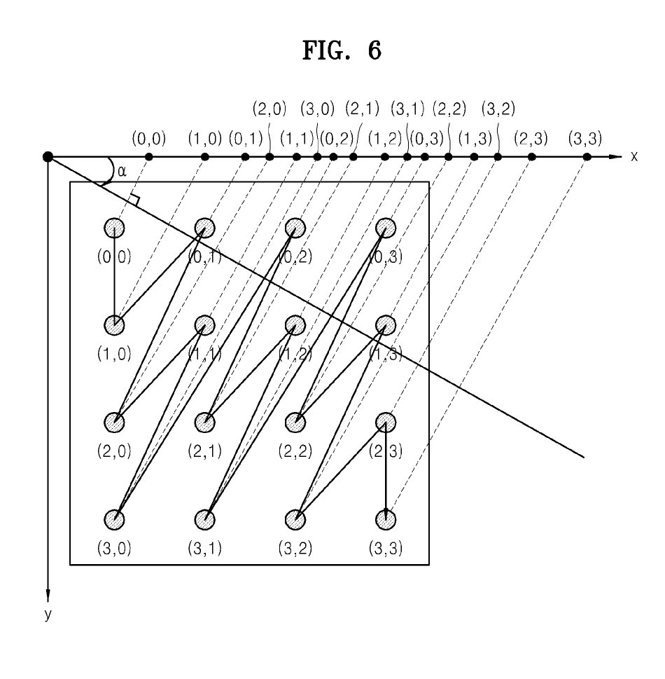

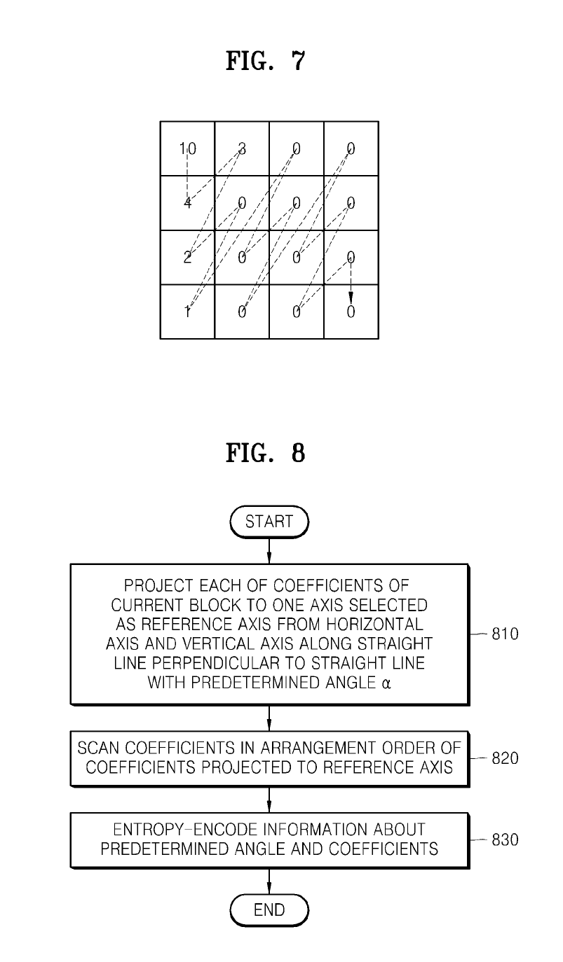

FIG. 6 is a reference diagram illustrating a scan order applied to coefficients of a 4×4 block, according to an exemplary embodiment. FIG. 7 is a diagram illustrating coefficients scanned in the scan order of FIG. 6, according to an exemplary embodiment.

Referring to FIG. 6, the scanning unit 425 projects each of coefficients of a current block to a horizontal axis x along a straight line perpendicular to a straight line with a predetermined angle α from the horizontal axis x that is a reference axis. When an arbitrary coefficient located in an xth row and a yth column is expressed as (x, y), coefficients (0, 0), (1, 0), (0, 1), (2, 0), (1, 1), (3, 0), (0, 2), (2, 1), (1, 2), (3, 1), (0, 3), (2, 2), (1, 3), (3, 2), (2, 3), and (3, 3) are sequentially scanned in FIG. 6. Referring to FIG. 7, if coefficients of a current block as shown in FIG. 7 are scanned in the scan order of FIG. 6, scanned coefficients are {10, 4, 3, 2, 0, 1, 0, 0, 0, 0, 0, 0, 0, 0, 0, 0}.

As described above, since if a predetermined angle α is 0 degrees, a scan order is determined to be a vertical scan order, if the predetermined angle α is 45 degrees, a scan order is determined to be a zigzag scan order, and if the predetermined angle α is 90 degrees, a scan order is determined to be a horizontal scan order, according to the present exemplary embodiment, various scan orders including a related art scan order may be defined by using only one angle α.

Meanwhile, in order to determine a scan order which enables coefficients of a current block to be arranged most efficiently, the scanning unit 425 may scan and output coefficients of a current block in different scan orders by using a plurality of angles, compare costs obtained after encoding performed by the entropy-encoding unit 430 according to the different scan orders, and determine a scan order with a smallest cost as a scan order to be finally applied to the current block. That is, the scanning unit 425 changes the predetermined angle α into at least one changed angle α′, compares a cost obtained after scanning and entropy-encoding coefficients at the changed angle α′ with a cost obtained after scanning and entropy-encoding coefficients at the predetermined angle α, and determines an angle with a smallest cost as a final angle for determining a scan order of the coefficients. Information about the scan order of the current block, that is, information about the angle α used to determine the scan order, is encoded by the entropy-encoding unit 430. In this case, if information about the scan order is added every block, the number of bits may be increased. Accordingly, the information about the scan order may be encoded by selecting one of a plurality of predefined angles in units of sequences or frames. For example, a scanning method using one of predefined angles α1, α2, and α3 may be performed in the same sequence or frame.

FIG. 8 is a flowchart illustrating a method of encoding an image using an adaptive coefficient scan order, according to an exemplary embodiment.

Referring to FIG. 8, in operation 810, each of coefficients of a current block is projected to an axis, selected as a reference axis from among a horizontal axis and a vertical axis, along a straight line perpendicular to a straight line with a predetermined angle α from the reference axis.

In operation 820, a scan order is determined according to an arrangement order of coefficients projected to the reference axis, and the coefficients are scanned in the determined scan order. As described above, coefficients may be sequentially scanned in an arrangement order in which coefficients projected to a reference axis are arranged on the reference axis starting from a DC coefficient.

In operation 830, information about the predetermined angle and the scanned coefficients is entropy-encoded.

As described above, when the scan order is determined and the coefficients scanned in the determined scan order are input, the entropy-encoding unit 430 generates a significant map Sigmap by expressing a significant coefficient having a value other than 0 by ‘1’ and a coefficient having a value 0 as ‘0’. In the significant map Sigmap, an EOB flag indicating whether each coefficient is a last significant coefficient is allocated to each of significant coefficients whose values are 1.

Meanwhile, if there exists only the DC coefficient, for example, if a quantization parameter QP is large, there is no change in arrangement types of scanned coefficients even though various scan orders are used. Accordingly, in order to reduce overhead when there exists only the DC coefficient, the entropy-encoding unit 430 may not encode angle information for determining a scan order. That is, the entropy-encoding unit 430 determines whether the DC coefficient is a last significant coefficient by using the significant map Sigmap and the EOD flag, and may encode angle information for determining a scan order only when the DC coefficient is not a last significant coefficient.

Also, in order to reduce overhead, the entropy-encoding unit 430 may encode angle information for determining a scan order by allocating ‘0’ to angle information about a predetermined angle for determining a scan order which frequently occurs, and allocating other values to other angles. For example, if a zigzag scan order, a horizontal scan order, and a vertical scan order may be used but the zigzag scan order is selected as a scan order most suitable to scan coefficients of a current blocks, compression efficiency may be improved by performing entropy-encoding by allocating ‘0’ to the zigzag scan order and respectively allocating ‘01’ and ‘10’ to the horizontal scan order and the vertical scan order.

As described above, since the method of encoding the image using the adaptive coefficient scan order according to the present exemplary embodiment may use various scan orders with small overhead, compression efficiency according to image characteristics may be improved.

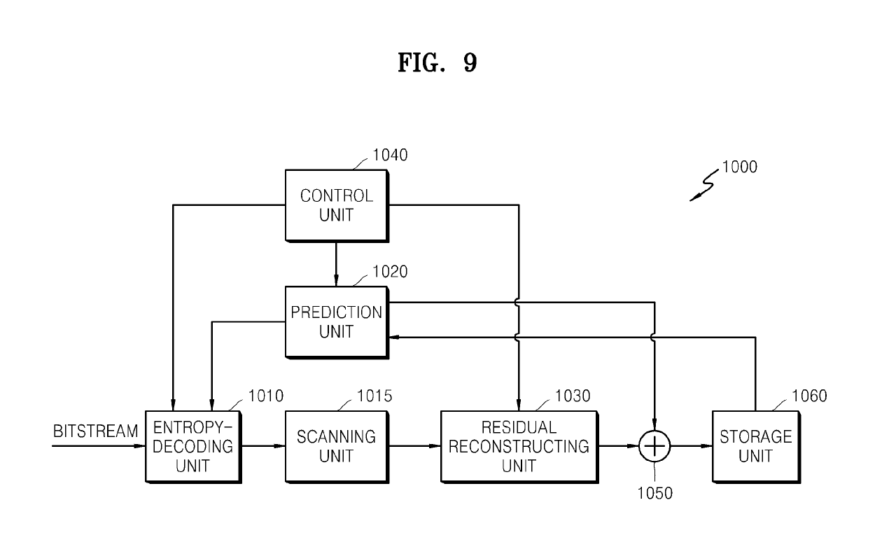

FIG. 9 is a block diagram illustrating an apparatus 1000 for decoding an image using an adaptive coefficient scan order, according to an exemplary embodiment.

Referring to FIG. 9, the apparatus 1000 includes an entropy-decoding unit 1010, a prediction unit 1020, a residual reconstructing unit 1030, a control unit 1040, an addition unit 1050, a scanning unit 1015, and a storage unit 1060.

The entropy-decoding unit 1010 acquires angle information about a predetermined angle for determining a scan order and information about coefficients of a current block to be decoded from an input bitstream. By using the angle information for determining the scan order, the scanning unit 1015 projects each of the coefficients of the current block to an axis, selected as a reference axis from among a horizontal axis and a vertical axis, along a straight line perpendicular to a straight line with the predetermined angle from the reference axis, and determines a scan order based on an arrangement order of coefficients projected to the reference axis, as described above. The scanning unit 1015 rearranges the coefficients extracted from the entropy-decoding unit 1010 and outputs the rearranged coefficients to the residual reconstructing unit 1030. The residual reconstructing unit 1030 reconstructs residual data by performing inverse quantization and inverse transformation on transform coefficients. The prediction unit 1020 generates and outputs a predicted image according to a prediction mode of the current block extracted from the bitstream. The addition unit 1050 reconstructs the current block by adding the reconstructed residual and the predicted image. The reconstructed current block is stored in the storage unit 1050, and is used to decode a next block. The control unit 1040 controls each element of the apparatus 1000.

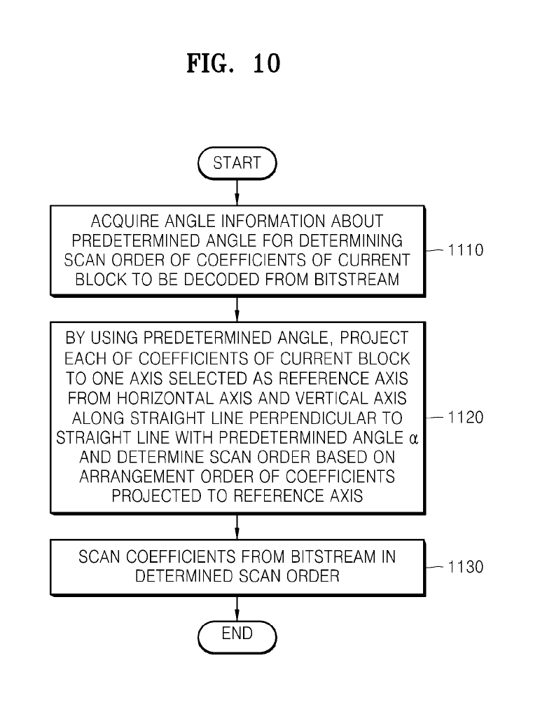

FIG. 10 is a flowchart illustrating a method of decoding an image using an adaptive coefficient scan order, according to an exemplary embodiment.

Referring to FIG. 10, in operation 1010, angle information about a predetermined angle α for determining a scan order of coefficients of a current block to be decoded from a bitstream is acquired.

In operation 1020, by using the acquired angle information, each of the coefficients of the current block is projected to an axis selected as a reference axis, from among a horizontal axis and a vertical axis, along a straight line perpendicular to a straight line with the predetermined angle α from the reference axis, and a scan order of the coefficients is determined based on an arrangement order of coefficients projected to the reference axis.

In operation 1030, the coefficients acquired from the bitstream in the determined scan order are rearranged and output. The rearranged and output coefficients are subjected to inverse quantization and inverse transformation to generate residual data. The current block is reconstructed by adding the generated residual data and a predicted image of the current block.

As described above, image compression efficiency may be improved by efficiently defining various scan orders by using only angle information.

Exemplary embodiments may be embodied as computer-readable codes in a computer-readable recording medium. The computer-readable recording medium may be any recording apparatus capable of storing data that is read by a computer system. Examples of the computer-readable recording medium include read-only memories (ROMs), random-access memories (RAMs), CD-ROMs, magnetic tapes, floppy disks, and optical data storage devices. The computer readable medium may be distributed among computer systems that are interconnected through a network, and an exemplary embodiment may be stored and implemented as computer readable codes in the distributed system. Moreover, one or more units of the encoding apparatus 400 and decoding apparatus 1000 can include a processor or microprocessor executing a computer program stored in a computer-readable medium.

While exemplary embodiments have been particularly shown and described above using specific terms, the exemplary embodiments and terms are merely illustrative and should not be construed as limiting the scope of the present inventive concept as defined by the claims. Accordingly, it will be understood by those of ordinary skill in the art that various changes in form and details may be made therein without departing from the spirit and scope of the present inventive concept as defined by the following claims.

What is claimed is:

1. A method of encoding an image using an adaptive coefficient scan order, the method comprising:
projecting coefficients of a current block to a reference axis, from among a horizontal axis and a vertical axis, along a first straight line perpendicular to a second straight line with a predetermined angle α from the reference axis;
scanning the coefficients of the current block in an arrangement order of the projected coefficients projected to the reference axis; and
entropy-encoding information about the predetermined angle α and the scanned coefficients.

2. The method of claim 1, wherein the predetermined angle α ranges from 0 to 90 degrees from the reference axis.

3. The method of claim 1, wherein the scanning the coefficients comprises sequentially scanning the coefficients of the current block in an arrangement order in which the projected coefficients projected to the reference axis are arranged on the reference axis starting from a direct current (DC) coefficient.

4. The method of claim 1, wherein the predetermined angle α is determined from among a first predetermined angle α1 and a second predetermined angle α2 by comparing a cost obtained after scanning and entropy-encoding the coefficients of the current block at the first predetermined angle α1 with a cost obtained after scanning and entropy-encoding the coefficients at the second predetermined angle α2.

5. The method of claim 1, wherein the predetermined angle α is determined from among a plurality of angles set to be applied to at least one picture unit.

6. The method of claim 1, wherein the plurality of angles comprises an angle of 0 degrees corresponding to a vertical scan order, an angle of 90 degrees corresponding to a horizontal scan order, and an angle between 0 degrees and 90 degrees corresponding to a zigzag scan order.

7. The method of claim 1, wherein the entropy-encoding the information about the predetermined angle α and the scanned coefficients comprises:
determining whether there exists a significant coefficient whose value is not 0 other than a DC coefficient of the current block; and
if it is determined that there exists no significant coefficient whose value is not 0 other than the DC coefficient, not encoding the information about the predetermined angle α.

8. An apparatus for encoding an image using an adaptive coefficient scan order, the apparatus comprising:
a scanning unit which projects coefficients of a current block to a reference axis, from among a horizontal axis and a vertical axis, along a first straight line perpendicular to a second straight line with a predetermined angle α from the reference axis, and scans the coefficients of the current block according to an arrangement order of the projected coefficients projected to the reference axis; and
an entropy-encoding unit that entropy-encodes information about the predetermined angle α and the scanned coefficients.

9. The apparatus of claim 8, wherein the predetermined angle ‘α’ ranges from 0 to 90 degrees from the reference axis.

10. The apparatus of claim 8, wherein the scanning unit sequentially scans the coefficients of the current block according to an arrangement order in which the projected coefficients projected to the reference axis are arranged on the reference axis starting from a DC coefficient.

11. The apparatus of claim 8, wherein the entropy-encoding unit determines the predetermined angle α from among a first predetermined angle α1 and a second predetermined angle α2 by comparing a cost obtained after scanning and entropy-encoding the coefficients of the current block at the first predetermined angle α1 with a cost obtained after scanning and entropy-encoding the coefficients of the current block at the second predetermined angle α2.

12. The apparatus of claim 8, wherein the predetermined angle α is determined from among a plurality of angles which are set to be applied to at least one picture unit.

13. The apparatus of claim 8, wherein the entropy-encoding unit determines whether there exists a significant coefficient whose value is not 0 other than a DC coefficient of the current block, and if it is determined that there exists no significant coefficient whose value is not 0 other than the DC coefficient, not encodes the angle information about the predetermined angle α.

14. A method of decoding an image using an adaptive coefficient scan order, the method comprising:
acquiring angle information about a predetermined angle α for determining a scan order of coefficients of a current block to be decoded from a bitstream;
using the predetermined angle α, projecting the coefficients of the current block to a reference axis, from among a horizontal axis and a vertical axis, along a first straight line perpendicular to a second straight line with the predetermined angle α from the reference axis, and determining the scan order based on an arrangement order of the projected coefficients projected to the reference axis; and
scanning the coefficients of the current block from the bitstream in the determined scan order.

15. The method of claim 14, wherein the predetermined angle α ranges from 0 to 90 degrees from the reference axis.

16. The method of claim 14, wherein the scanning the coefficients comprises sequentially scanning the coefficients of the current block in an arrangement order in which the projected coefficients projected to the reference axis are arranged on the reference axis starting from a DC coefficient.

17. The method of claim 14, wherein the predetermined angle α is determined from among a plurality of angles which are set to be applied to at least one picture unit.

18. An apparatus for decoding an image using an adaptive coefficient scan order, the apparatus comprising:
an entropy-encoding unit which acquires angle information about a predetermined angle α for determining a scan order of coefficients of a current block to be decoded from a bitstream; and
a scanning unit which, using the predetermined angle α, projects the coefficients of the current block to a reference axis, from among a horizontal axis and a vertical axis, along a first straight line perpendicular to a second straight line with the predetermined angle α from the reference axis, to determine the scan order based on an arrangement order of the projected coefficients projected to the reference axis, and scans the coefficients of the current block from the bitstream in the determined scan order.

19. The apparatus of claim 18, wherein the predetermined angle αranges from 0 to 90 degrees from the reference axis.

20. The apparatus of claim 18, wherein the scanning unit sequentially scans the coefficients of the current block in an arrangement order in which coefficients projected to the reference axis are arranged on the reference axis starting from a DC coefficient.

21. The apparatus of claim 18, wherein the predetermined angle α is determined from among a plurality of angles which are set to be applied to at least one picture unit.

22. A computer readable recording medium having recorded thereon a program executable by a computer for performing the method of claim 1.

23. A computer readable recording medium having recorded thereon a program executable by a computer for performing the method of claim 14.

24. A method of encoding an image using an adaptive coefficient scan order, the method comprising:
scanning coefficients of a current block according to a determined scanning order;
entropy-encoding information about a predetermined angle α and the scanned coefficients,
wherein the scanning order is determined to correspond to an arrangement order of the coefficients projected to a reference axis, from among a horizontal axis and a vertical axis, along a first straight line perpendicular to a second straight line with the predetermined angle α from the reference axis.

25. A computer readable recording medium having recorded thereon a program executable by a computer for performing the method of claim 24.
